(19) United States
(12) Patent Application Publication
(10) Pub. No.: US 2011/0175908 A1
(43) Pub. Date: Jul. 21, 2011

(54) Image Effect Display Method and Electronic Apparatus Thereof

(75) Inventors: Kuo-Chang Fu, Hsinchu Hsien (TW); Ruen-Rone Lee, Hsinchu Hsien (TW); Sheng Chi Yu, Hsinchu Hsien (TW)

(73) Assignee: MSTAR SEMICONDUCTOR, INC., Hsinchu Hsien (TW)

(21) Appl. No.: 13/005,648

(22) Filed: Jan. 13, 2011

(30) Foreign Application Priority Data
Jan. 15, 2010 (TW) 099101073

(51) Int. Cl. G09G 5/00; G06T 15/00

(52) U.S. Cl. 345/419; 345/619

(57) ABSTRACT

An image effect display method for displaying image effect during switching between a plurality of picture statuses includes providing a database, which includes a plurality of object models and a plurality of image effect templates; providing a status lookup table, which includes corresponding relationships between the plurality of picture statuses and the plurality of object models, and corresponding relationships between switching the picture statuses and the image effect templates; generating image effect data according to the database and the status lookup table by a transform program; and displaying a corresponding image effect according to the image effect data when one of the picture statuses is switched to another of the plurality of the picture statuses.

### CROSS REFERENCE TO RELATED PATENT APPLICATION

This patent application is based on Taiwan, R.O.C. patent application No. 099101073 filed on Jan. 15, 2010.

### FIELD OF THE INVENTION

The present invention relates to an image effect display method and electronic apparatus thereof, and more particularly, to an image effect display method and electronic apparatus thereof during switching between picture statuses.

### BACKGROUND OF THE INVENTION

As a digital display technique of various electronic products develops, users widely pursue consumer electronic products having advantages of design novelty, operating convenience and intuitive interface. For example, operating interfaces of current mainstream smart phones or video players already adopt graphical user interface (GUI) having plentiful pictures instead of original simple character menus. In particular, most of current GUIs have stereo image effects, and different transition image effects, such as animations and motion pictures, are added to the GUIs during switching between different pictures to bring vividness to display modes of the electronic products in order to attract user attention.

FIG. 1 shows a schematic diagram of a transition image effect of a conventional electronic apparatus during switching between different picture statuses. FIG. 1 illustrates display pictures T1 to T6 at six different time points. A display menu in the display picture T1 corresponds to a picture status of a presentation slide function. Suppose that a user switches the electronic apparatus to another picture status of a digital television (TV) application function as shown in the display picture T6 by various input approaches such as a touch operation or pressing corresponding buttons. During switching from the picture status in the display picture T1 to the picture status in the display picture T6, a dynamic transition image effect, e.g., from the display picture T2 to the display picture T5, is displayed on the electronic apparatus.

In a conventional transition image effect display method, art designers of electronic product manufactures need to first draw one by one storyboards during switching between different picture statuses, and each of the storyboards is similar to any one of the display picture T2 to display picture T5. After that, software engineers or GUI software designer write one by one program codes corresponding to each of the storyboards, so that the electronic apparatus can complete display of transition pictures according to the program codes.

In order to display the dynamic display effect more vividly and with more detail, storyboards of the transition effect between picture statuses need to be more finely divided to achieve a consecutive dynamic effect. When there is more possible options for the pictures statuses (e.g., more application functions are added), the to-be-written storyboard program codes quickly grow in multiples. In particular, in the event that storyboard pictures have a stereo three-dimensional (3D) effect, when program codes for depicting the stereo 3D effect are written by human resources, various minute and complicated things, e.g., angle, distance, line and shadow of a certain object of each picture, need to be defined one by one, such that the flow of writing program codes for the transition pictures become extremely redundant, resource consuming and lacking in time efficiency.

In order to solve the foregoing problem, an image effect display method and electronic apparatus thereof capable of effectively managing object models and image effect templates involved in a transition effect and converting the transition effect to an image effect data according to a status lookup table representing picture statuses, so as to display different image effects based on the image effect data to solve the foregoing problem.

### SUMMARY OF THE INVENTION

One object of the present invention is to provide an image effect display method, which is capable of displaying an image effect during switching between different picture statuses, e.g., a transition image effect.

According to an embodiment of the present invention, an image effect display method comprises providing a database, which comprises a plurality of object models and a plurality of image effect templates; providing a status lookup table, which comprises corresponding relationships between pictures statuses and the object models, and corresponding relationships between switching the picture statuses and the image effect templates; generating image effect data by a transform program according to the database and the status lookup table; and displaying a corresponding image effect according to the image effect data when one of the picture statuses is switched to another of the picture statuses.

According to another embodiment of the present invention, an image effect display method, applied to an electronic apparatus comprising image effect data and a processing module, comprises receiving a status switch command; and displaying a corresponding image effect by the processing module according to a current picture status, a next picture status corresponding to the status switch command, and the image effect data.

In this embodiment, the image effect data is generated by a transform program according to a database and a status lookup table. The database comprises a plurality of object models and a plurality of image effect templates. The status lookup table comprises corresponding relationships between a plurality of picture statuses and the object models, and corresponding relationships between switching the picture statuses and the image effect templates.

Another object of the present invention is to provide an electronic apparatus, which comprises a display module, a receiving module, a memory module, and a processing module. The receiving module receives a status switch command. The memory module stores image effect data. The processing module displays a corresponding image effect on the display module according to a current picture status, a next picture status corresponding to the status switch command, and the image effect data.

In this embodiment, the image effect data is generated by a transform program according to a database and a status lookup table. The database comprises a plurality of object models and a plurality of image effect templates. The status lookup table comprises corresponding relationships between a plurality of picture statuses and the object models, and corresponding relationships between switching the picture statuses and the image effect templates.

Compared to the prior art, the image effect display method and electronic apparatus thereof build a database comprising the object models and the image effect templates, and a status lookup table comprising switch relationships of the picture statuses. The database and the status lookup table are converted to image effect data. Accordingly, the electronic apparatus is capable of displaying different image effects based on the image effect data.

The advantages and spirit related to the present invention can be further understood via the following detailed description and drawings.

### BRIEF DESCRIPTION OF THE DRAWINGS

FIG. 1 is a schematic diagram of a transition image effect of a conventional electronic apparatus during switching between different picture statuses.

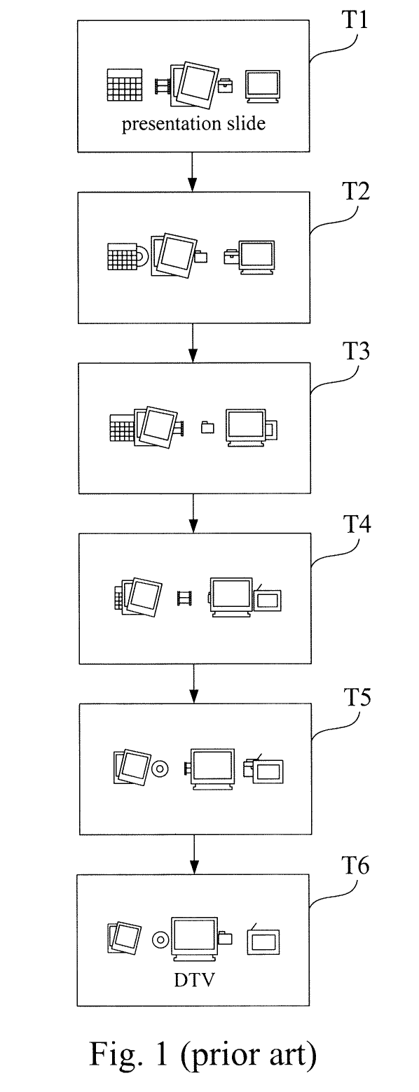

FIG. 2 is a flow chart of an image effect display method in accordance with an embodiment of the present invention.

FIG. 3 is schematic diagram of an image effect during switching between picture statuses.

FIG. 4 is a schematic diagram of a status lookup table in the first embodiment.

FIG. 5 is a block diagram of an electronic apparatus in accordance with an embodiment of the present invention.

FIG. 6 is a flow chart of an image effect display method associated with an electronic apparatus in accordance with an embodiment of the present invention.

### DETAILED DESCRIPTION OF THE PREFERRED EMBODIMENT

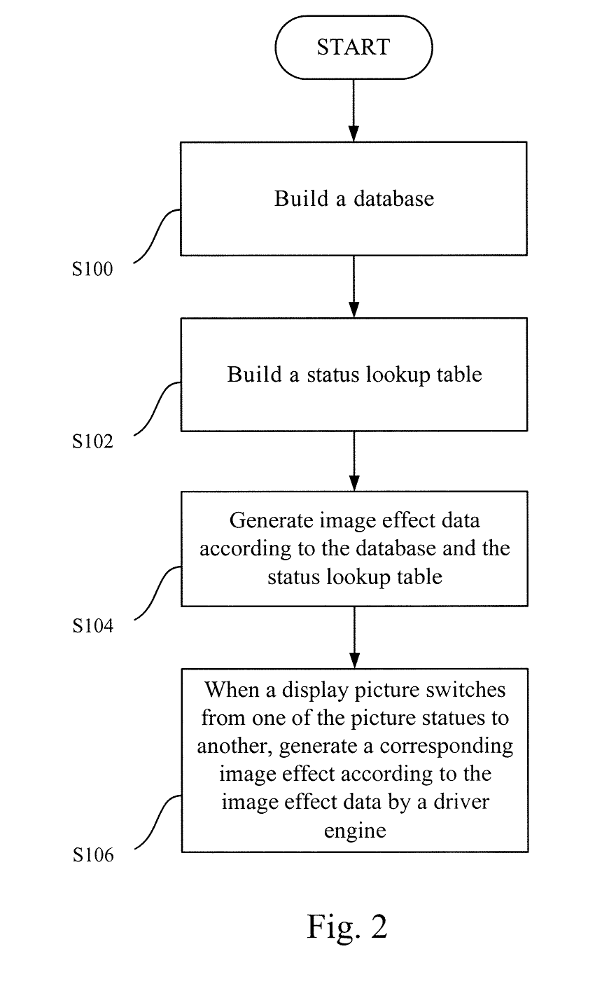

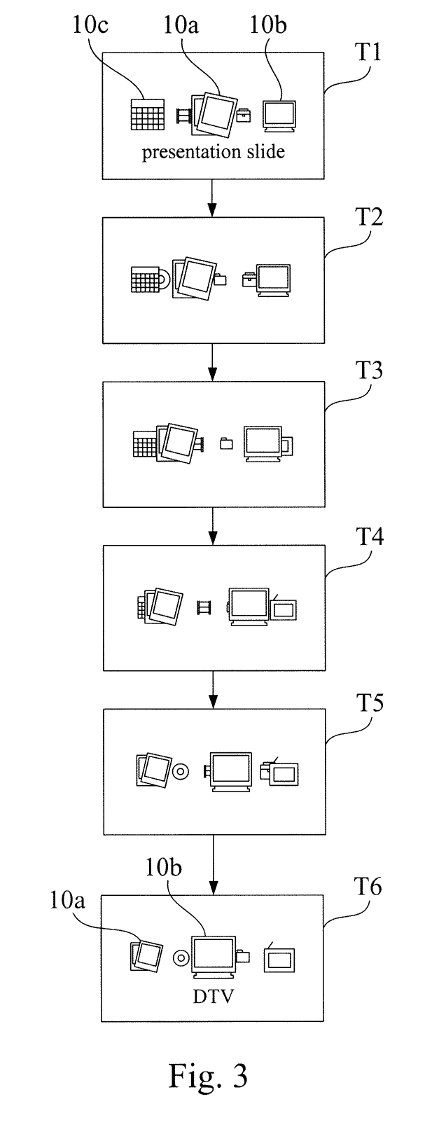

FIG. 2 shows a flow chart of an image effect display method in accordance with an embodiment of the present invention. The image effect display method is capable of displaying an image effect during switching between a plurality of picture statues. FIG. 3 shows a schematic diagram of an image effect during switching between a plurality of picture statues. FIG. 3 illustrates display pictures T1 to T6 at six different time points.

Referring to FIG. 2, the image effect display method begins with Step S100 in which a database comprising a plurality of object models and a plurality of image effect templates is built.

The foregoing object models can be 3D animation models, object planes, stereo figures, frame lines, color blocks, buttons or background pictures. For example, in the display picture T1 in FIG. 3, three object models (10a, 10b and 10c) are figures which represent functions of a slide, a television (TV) and a spreadsheet, respectively.

Each of the image effect templates comprises a motion direction, a motion path, and a motion speed of an object model, and/or a luminance definition, shadow or a chrominance gradient effect of the object model. In FIG. 3, when the display picture T1 is switched to the display picture T6, image effect templates of leftward rotation and gradual zooming out are implemented to the object model 10a, and image effect templates of leftward rotation and gradual zooming in are implemented to the object model 10b.

In practical applications, an approach for building the database in Step S100 comprises retrieving the object models and the image effect templates from at least one stereo image file. Generally, stereo image files, e.g., conforming to 3DS, LWO, OBJ, XSI or C4D stereo image formats, applied to various business image software programs comprise stereo information of each object of an image, such as information of a length, a width, a height, transparency, surface material, color and mass center of the object, and information of a motion path, shadow, light effect and distance definition when the object is moving. For example, in Step S100, object models and image effect template information covered in the stereo image file can be retrieved by an analysis retrieve application program.

In addition, in Step S102, a status lookup table is built. The status lookup table comprises corresponding relationships between the picture statues and the object models, and comprises corresponding relationships between the picture statuses and the image effect templates when switching between picture statues.

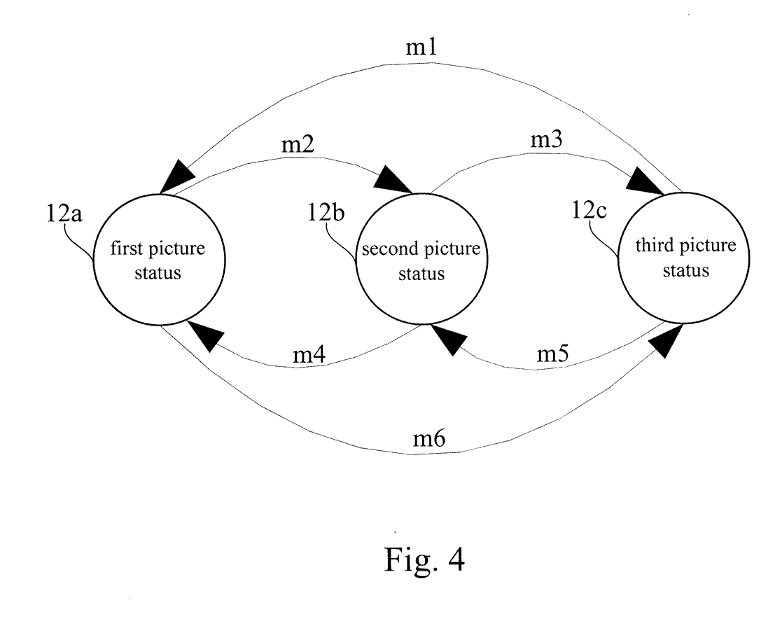

FIG. 4 shows a schematic diagram of the statues lookup table in this embodiment. The status lookup table comprises various dynamic image definitions adopted during switching between two of a first picture status 12a, a second picture status 12b and a third picture status 12c. For example, when the first picture status 12a is switched to the second picture status 12b, a dynamic image definition m2 comprising object models covered in the first and second picture statuses and image effect templates adopted during switching between the first picture status and the second picture status is adopted.

In Step S104, image effect data are generated according to the database and the status lookup table. In practical applications, the step of generating the image effect data is achieved by a transform program. That is, by automatically combining content of the database and the status lookup table via the transform program, the image effect data is generated in the form of program codes. Further, the image effect data are converted to effect data having a data structure that is convenient for an electronic apparatus to execute, and the converted effect data are stored into the electronic apparatus.

When a display picture of the electronic apparatus switches from one of the picture statues to another, the flow proceeds to Step S106 in which a corresponding image effect is displayed according to the image effect data by a driver engine.

The driver engine, which can be a software application program or a software execution platform, accesses and executes the data structure of the converted image effect data to display a predetermined image effect on the electronic apparatus.

For example, in FIG. 3, when the picture status representing presentation slide function (i.e., the display picture T1) is switched to another picture status representing the digital TV function (i.e., the display picture T6), the driver engine accesses the image effect data, so that each object moves or rotates along a predetermined track, and has image effect of zooming in or zooming out.

In addition, when a user interface needs to be altered, e.g., adding or removing a function figure (i.e., an object model), adding an explosive special effect (i.e., an image effect template), changing a motion direction (i.e., an image effect template) or altering subordinate relationships and switch relationships between the picture statues (e.g., a status lookup table), according to the present disclosure, Step S104 is iterated after the foregoing alternation completes, i.e., the image effect data are generated according to the altered database and the altered status lookup table. After that, the updated image effect can be displayed by the driver engine.

In the foregoing embodiment, the steps of the image effect display method can be completed by a single electronic apparatus, or be completed by an electronic system comprising a plurality of electronic apparatuses, respectively.

For the current terminal consumer electronic products, it is important to effectively utilize their limited hardware resources. Therefore, in the foregoing embodiment, Step S100 in which the database is built, Step S102 in which the status lookup table is built and Step S104 in which image effect data are generated can be in advance completed on a computer system by a manufacture or a software designer. That is, when a user interface is designed, the desired database and the status lookup tale are built in advance, and the built database and status lookup table are automatically converted by the transform program to program codes of the image effect data. The program codes can be further converted to the effect data having the data structure that is convenient for the electronic apparatus to execute, and the converted effect data are stored into the electronic apparatus. Compared to the prior art in which the desired image program codes for displaying each dynamic picture are completed by human resources, the flow of automatic conversion by the transform program provided by the present invention provides higher processing efficiency to reduce working time and cost for designing interfaces of products.

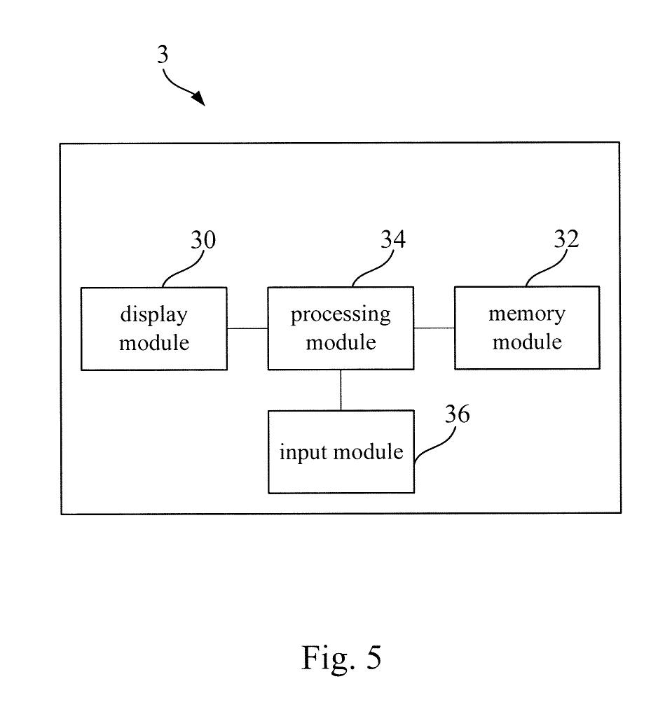

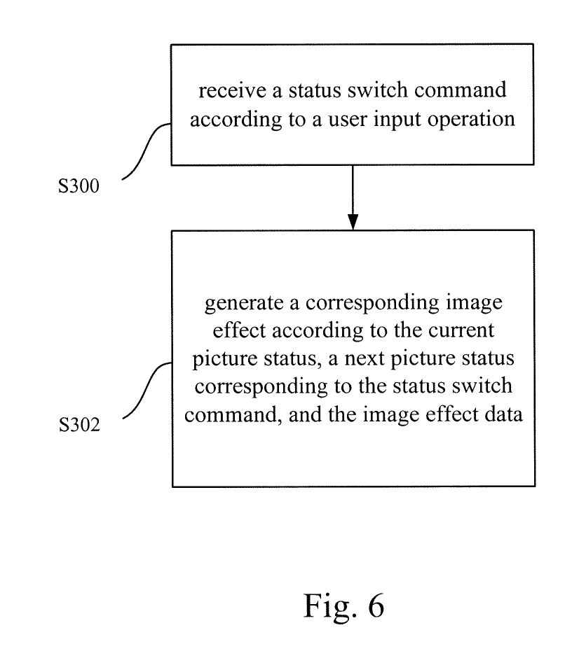

When the image effect data are in advance generated by the computer system, the electronic apparatus achieves dynamic image effect in the foregoing embodiment by adopting least hardware resources. FIG. 5 shows a block diagram of an electronic apparatus 3 in accordance with an embodiment of the present invention. FIG. 6 is a flow chart of an image effect display method associated with the electronic apparatus 3.

As shown in FIG. 5, the electronic apparatus 3 comprises a display module 30, a memory module 32, a processing module 34, and an input module 36. The display module 30 displays a display picture. The memory module 32 is stored with image effect data. A transform program is first executed by a computer system, and the image effect data is then generated according to a database and a status lookup table. The database comprises a plurality of object models and a plurality of image effect templates. The object models can be 3D animation models, or planes or stereo figures of objects. For example, each of the image effect templates each a motion direction, a motion path, and a motion speed of an object model.

The status lookup table comprises corresponding relationships between a plurality of picture statuses and the object models, and corresponding relationships between the picture statuses and the image effect templates when switching between two picture statuses.

The electronic apparatus 3 performs Step S300 in which an input model 36 of the electronic apparatus receives a status switch command according to a user input operation (e.g., a press of a button, a touch operation or an audio control operation). The status switch command prompts the electronic apparatus 3 to switch the display picture from a current picture status to a next picture status.

When the processing module receives the status switch command, the electronic apparatus 3 performs Step S302 in which a driving engine is activated by the processing module 34. The driving engine can be a software module (e.g., a software application program or a software execution platform). A corresponding image effect is displayed on the display model according to the current picture status, a next picture status corresponding to the status switch command, and the image effect data by the driving engine.

That is, the electronic apparatus 3 only needs to in advance store the image effect data, which has been converted to an effect data having a data structure that is convenient for the electronic apparatus 3 to execute. When the picture status is switched, the electronic apparatus 3 accesses the image effect data by the driving engine, and displays the corresponding image effect on the display module. Information contained in the image effect data, the approach and principle for in advance building the image effect data are approximately similar to those described in the first embodiment, and shall not be described for brevity.

In conclusion, according to the present disclosure, an image effect display method and electronic apparatus thereof in advance build a database comprising a plurality of object models and a plurality of image effect templates, and build a status lookup table comprising switch relationships between the picture statuses. The database and the status lookup table are converted to image effect data. Accordingly, the electronic apparatus achieves displaying various image effects based on the image effect data.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An image effect display method, for displaying image effects during switching between a plurality of picture statuses, the method comprising:
providing a database which comprises a plurality of object models and a plurality of image effect templates;
providing a status lookup table which comprises corresponding relationships between the plurality of picture statuses and the plurality of object models, and corresponding relationships between switching the plurality of picture statuses and the plurality of image effect templates;
generating image effect data according to the database and the status lookup table by a transform program; and
generating a corresponding image effect according to the image effect data when one of the picture statuses is switched to another of the picture statuses.

2. The method as claimed in claim 1, wherein the step of providing the database comprises retrieving the plurality of object models and the plurality of image effect templates from at least one stereo image file.

3. The method as claimed in claim 1, wherein the plurality of object models are three-dimensional (3D) animation models.

4. The method as claimed in claim 1, wherein the corresponding image effect is generated according to the image effect data by a software module.

5. An image effect display method, applied to an electronic apparatus comprising image effect data and a processing module, the method comprising:
receiving a status switch command; and
generating by the processing module a corresponding image effect according to a current picture status, a next picture status corresponding to the status switch command, and the image effect data;
wherein, the image effect data is generated according to a database and a status lookup table by a transform program; the database comprises a plurality of object models and a plurality of image effect templates; and the status lookup table comprises corresponding relationships between the plurality of picture statuses and the object models, and corresponding relationships between switching the plurality of picture statuses and the plurality of image effect templates.

6. The method as claimed in claim 5, wherein the plurality of object models and the plurality of image effect templates are retrieved from at least one stereo image file.

7. The method as claimed in claim 5, wherein the object models are 3D animation models.

8. The method as claimed in claim 5, wherein the processing module generates the corresponding image effect by using a software module.

9. An electronic apparatus, comprising:
a display module;
a receiving module, for receiving a status switch command;
a memory module, stored with image effect data; and
a processing module, for generating a corresponding image effect to the display module according to a current picture status, a next picture status corresponding to the status switch command, and the image effect data;
wherein, the image effect data are generated according to a database and a status lookup table by a transform program; the database comprises a plurality of object models and a plurality of image effect templates; and the status lookup table comprises corresponding relationships between the plurality of picture statuses and the plurality of object models, and corresponding relationships between switching the plurality of picture statuses and the plurality of image effect templates.

10. The electronic apparatus as claimed in claim 9, wherein the plurality of object models and the plurality of image effect templates are retrieved by a computer system from at least one stereo image file.

11. The electronic apparatus as claimed in claim 9, wherein the plurality of object models are 3D animation models.

12. The electronic apparatus as claimed in claim 9, wherein the image effect data are generated according to the database and the status lookup table by a computer system.

13. The electronic apparatus as claimed in claim 9, wherein the processing module generates the corresponding image effect according to the current picture, the next picture status and the image effect data by executing a software module.
